(19) United States
(12) Patent Application Publication
(10) Pub. No.: US 2008/0186734 A1
(43) Pub. Date: Aug. 7, 2008

(54) Side-emitting backlight system and backlit display using the same

(75) Inventors: Danding Huang, Hong Kong (CN); Ying Liu, Hong Kong (CN); Shou Lung Chen, Hong Kong (CN); Huajun Peng, Hong Kong (CN); Kwan Wah Ng, Hong Kong (CN); Chen-Jung Tsai, Hong Kong (CN)

Correspondence Address: BUCHANAN, INGERSOLL & ROONEY PC, POST OFFICE BOX 1404, ALEXANDRIA, VA, 22313-1404, US

(73) Assignee: Kong Kong Applied Science and Technology Research Institute Co., Ltd., Hong Kong (CN)

(21) Appl. No.: 11/730,305

(22) Filed: Mar. 30, 2007

(30) Foreign Application Priority Data
Feb. 2, 2007 (HK) 07101319.5

(51) Int. Cl. F21V 8/00

(52) U.S. Cl. 362/612; 362/613

(57) ABSTRACT

A side-emitting backlight system for an image display panel, the system comprising a plurality of light emission units, each unit arranged so as to provide side light emission to region of an image display panel and having at least one light emission source; and a controller for individually controlling each light emission unit to vary at least one light characteristic of light emission from each light emission unit; wherein the at least one light characteristic is defined by determining at least one predefined parameter of light for each of a plurality of regions of an image to be displayed on the display panel, the region of the image corresponding to an adjacent light emission unit.

### FIELD OF THE INVENTION

The present invention relates to a backlit display, more particularly to a backlit display having a dynamically controlled side-emitting backlight system.

### BACKGROUND OF THE INVENTION

Side-emitting backlight systems are widely used in small-to-middle sized backlit display products, for example, liquid crystal displays, mobile phone screens, personal digital assistant (PDA) screens, laptop monitors, personal computer monitors, and etc. In general, a conventional side-emitting backlight system includes one or a pair of opposed regions each with a plurality of linearly arranged light emitting sources thereon for emission of light. The conventional side-emitting backlight system may also include a light guide extending perpendicular to the regions having a reflective bottom surface and an upper surface for emitting a surface light toward an upper side for the purpose of illuminating the display.

In recent developments, it has been realized that in order to achieve better image representation on the display, it is desirable to have different backlight when displaying different images. For example, bright backlight can better present vivid sky and buildings; whereas dimmed backlight can better present stars in the space. Therefore, dynamic control of the brightness and/or other characters of the backlight source has become more desirable.

However, most conventional dynamic controlled backlight system may require a large volume of calculation to process the input image for the purpose of compensating the adjustment in the backlight. Such a large volume of calculation may not be desirable.

It is an object of the present invention to provide a backlit display having an improved dynamically controlled side-emitting backlight system.

### SUMMARY OF THE INVENTION

In a first aspect, the present invention provides a side-emitting backlight system for an image display panel, the system comprising:

a plurality of light emission units, each unit arranged so as to provide side light emission to region of an image display panel and having at least one light emission source; and

a controller for individually varying at least one light characteristic of light emission from each light emission unit, wherein the at least one light characteristic is defined by determining at least one predefined parameter of light for each of a plurality of regions of an image to be displayed on the display panel, the regions of the image corresponding to an adjacent light emission unit.

The controller provides an image signal to the image display panel, wherein the image signal of each said region is provided responsive to the lighting characteristic of a corresponding light emission unit so as to display an image of at least one predetermined visual characteristic.

The plurality of light emission units may comprise a plurality of organic light emitting diode (OLED) films, a plurality of light emitting diodes (LED) or one or more cold cathode fluorescent lamps (CCFL).

Each light emission unit may include a plurality of RGB colour-separated LEDs, and each light emission includes a plurality of RGB LEDs in one package. Alternatively, each light emission unit includes a plurality of at least one blue or ultraviolet LED coated with phosphor material for downward conversion.

The backlight system preferably further comprising a plurality of light guides for directing light emitted from the light emission units in a direction towards the display panel. Preferably each light emission unit has associated therewith one or more light guides. The one or more light guides of each light emission unit preferably direct correspond to the corresponding region of the display panel associated with that light emission source. Preferably the light guides are arranged in a manner so as to reduce light interference between adjacent regions of the image display panel.

Each light guide may include a first side surface adjacent its corresponding group of light emitting sources for incidence of light from the corresponding group of light emitting sources into the light guide, and a second side surface through which light is emitted towards the display panel. Preferably each light guide includes a third side surface which is substantially light-impermeable for minimizing or reducing the interference between the light emission of different light emission units, and the third side surface of each light guide is substantially reflective and may be coated with substantially reflective materials. The second side surface of each light guide may be substantially diffusive.

The system may further comprise a driving unit for receiving a control signal from the controller and for controlling the at least one characteristic of the light emission of each light emission unit. The controller may individually adjust the brightness of the light emission of each light emission unit and may individually adjust the colour of the light emission of each light emission unit.

In another aspect, the present invention provides a display system comprising,

an image display panel;

a plurality of light emission units, each unit corresponding to an adjacent region of the image display panel and having at least one light emission source; and

a controller for individually varying at least one light characteristic of light emission from each light emission unit and for providing an image signal to the image display panel,

wherein the at least one light characteristic is defined by determining at least one predefined parameter of light for each of a plurality of regions of an image to be displayed on a display panel, the regions of the image corresponding to an adjacent light emission unit; and

the image signal of each said region is provided responsive to the lighting characteristic of a corresponding light emission unit so as to display an image of at least one predetermined visual characteristic.

The image display panel is preferably a liquid crystal display (LCD).

The display system may further comprise a system according to the fist aspect.

In a further aspect, the present invention provides a method of displaying an image on a backlit display, the method comprising the steps of:

determining at least one predefined parameter of light for each of a plurality of regions of an image to be displayed on a backlit display;

providing at least one light characteristic by a plurality of light emission units corresponding to each respective region of said plurality of regions responsive to said predefined parameter; and

providing an image signal to said display, wherein the image signal of each said region of the display is provided responsive to the lighting characteristic of a corresponding light emission unit so as to display an image of at least one predetermined visual characteristic.

The light emission units are preferably provided as side-emission light emission units.

The predefined parameter may be selected from the group including average value, peak value, dimming or intensity value or the like.

The light characteristic provided by the light emission units may be selected from the group including brightness, colour or combinations thereof.

### BRIEF DESCRIPTION OF THE DRAWINGS

Preferred embodiments of the present invention will be explained in further detail below by way of examples and with reference to the accompanying drawings, in which:

FIG. 1 shows a top plain view illustrating a first embodiment of a backlight system according to the present invention;

FIG. 2 shows a simplified diagram illustrating an exemplary circuitry of processing the input video signal according to the present invention;

FIG. 3 shows a flow chart illustrating an exemplary process of processing the input video signal according to the present invention;

FIG. 4 shows a top plain view illustrating a second embodiment of a backlight system according to the present invention;

FIG. 5 shows a top plain view illustrating a third embodiment of a backlight system according to the present invention; and

FIG. 6 shows a top plain view illustrating a fourth embodiment of a backlight system according to the present invention.

### DETAILED DESCRIPTION OF THE PREFERRED EMBODIMENTS

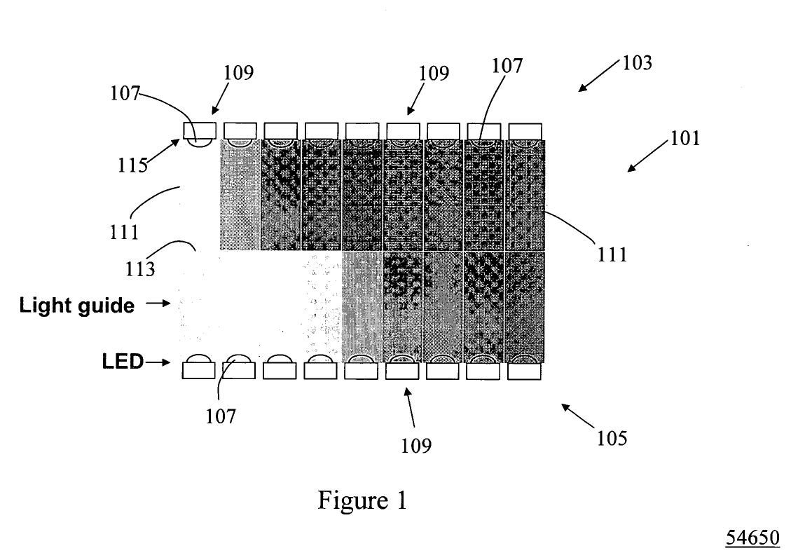

FIG. 1 illustrates an exemplary embodiment of a side-emitting backlight system 101 of the present invention suitable for use in a backlit display such as liquid crystal displays, mobile phone screens, personal digital assistant (PDA) screens, laptop monitors, personal computer monitors, and etc. The side emitting backlight system 101 includes 2 regions 103, 105, each having a plurality of light emitting diodes (LED) 107, which LEDs 107 are grouped into a plurality of blocks 109. The side-emitting backlight system 101 further includes a plurality of elongate light guides 111, each corresponding to a block of LEDs and extending substantially perpendicular to the regions 103, 105. In an exemplary embodiment, each block of LEDs may include RGB colour-separated LEDs, RGB LEDs in one package, white balanced colour separated LEDs, or blue or ultraviolet LED(s) coated with phosphor materials for downward conversions such that the light emission of each block is in white colour as will be understood by a skilled person in the art.

In the exemplary embodiment, each light guide 111 has a reflective bottom surface (not shown) and an upper surface that allows at least partial transmission of light therethrough for providing backlight to illuminate the display (not shown) thereabove as will be appreciated by a skilled person in the art. The upper surface may further be covered with a diffusive material or element for mixture of light. Alternatively, each light guide may have an upper surface and a diffusive plate on or adjacent the upper surface for the purpose of diffusion of light.

Furthermore, light emission of each block is restricted from penetrating into adjacent light guides so as to avoid or minimize interference between the light emission of different backlight blocks. In one exemplary embodiment, this is achieved by providing each light guide 111 with two reflective side surfaces and one distal reflective end 113 that is away from its corresponding region 103 such that light is restricted from penetrating through these surfaces and interfering with the light propagated in other light guides. Alternatively, the side surfaces and the distal end may be coated with substantially light-impermeable materials for minimizing emission of light therethrough.

In addition, each light guide 111 is arranged in close proximity to its corresponding block 109 (or light emitting source 107) at the proximal end 115 as well as the display or LCD panel thereabove for reducing interference between the backlight provided by different light emitting blocks. Each light guide 111 corresponds to a region of the display (now shown in FIG. 1) and illuminates its corresponding region only, which will be discussed in further detail.

The side-emitting backlight system also includes a controlling unit (not shown) for individually adjusting at least one character, for example, the brightness and/or the colour, of the light emission of each block in accordance with the input video or image signal to be displayed on the display.

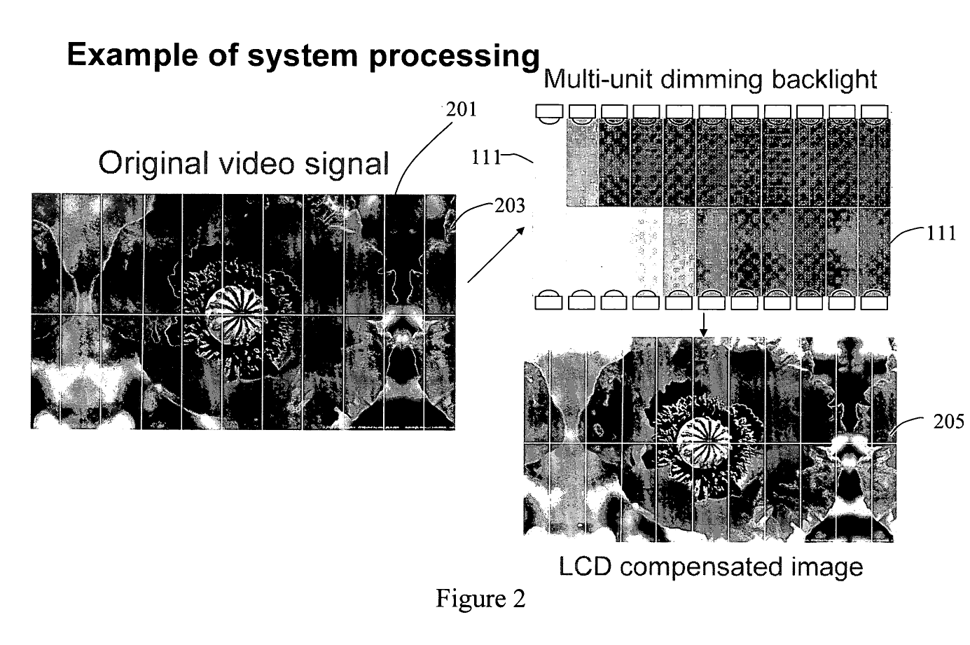

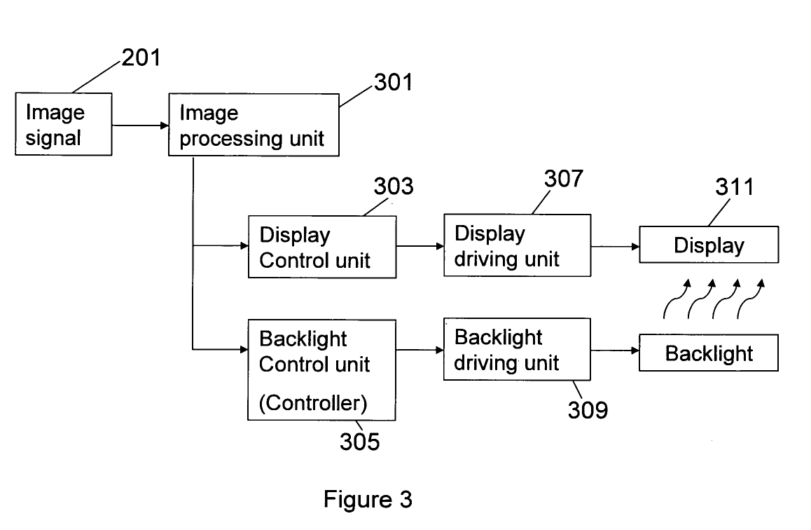

Referring to FIGS. 2 and 3, an exemplary process of processing and displaying on a backlit display of the input video or image signal is described.

Firstly, the input image signal 201 is passed on to both a display controller 303 and a backlight controller 305 through an image processing unit 301 which divides the input image signal 201 into a plurality of regions indicated by arrow 203 in accordance with the light guides 111 of the side emitting system.

In the present embodiment, a display control unit 303 receives the a modified signal from the image processing unit 301 which is then provided to a display 311 via a display driving unit 307. The signal from the backlight controller 305 is provided to a backlight via a backlight driving unit 309. The light emitted from the backlight is projected so as to combine with the modified image of the display 311 so as to provide a desire or required image on the display.

The backlight controller 205 determines at least one predefined parameter of light, such as brightness and/or colour for the light emission, based upon an image to be displayed on the display, and a signal indicative of such parameter is provided to each backlight block of each block in the corresponding region of the LCD panel. A modified or balanced video signal is then determined and provided to the display panel. This modified or balanced video signal is determined such that when in combination with the light emitted from an adjacent backlight block a desired or required visual image is provided.

As will be appreciated by those skilled in the art, numerous predefined parameters may be incorporated for determining a lighting characteristic, these parameters including average value, peak value, dimming or intensity value or the like, such as by averaging the values of the input video/image signal within the corresponding region, by selecting a maximum value of the input video/image signal within the corresponding region, and etc.

A skilled person will appreciate that by dividing the backlight system into a plurality of blocks, each being individually controlled, the calculation of the compensated display image can be simplified as only backlight from limited number of light guides is considered. Thereby, image processing can be accelerated, which can ease the real-time display of the input video/images. In addition, as each block of backlight can be turned on/off or dimmed individually, power consumption can be optimized.

A skilled person will further appreciated that the calculation of the compensated display image can be further simplified due to the minimized interference between the backlight from adjacent blocks of LEDs in the side-emitting backlight system. As each region on the display is only illuminated by its corresponding block of LEDs through the corresponding light guide, when calculating the compensated display image for each region, the display controller 303 only needs to take into consideration of the light emission of the corresponding block of LEDs, without the need of considering the light emission from other (for example adjacent) blocks or light guides. This will significantly reduce the volume of calculation in the image processing.

In addition, the brightness of each LED within one block can be adjusted either independently or uniformly in the exemplary embodiment. In the exemplary embodiment, due to the mixture of light within the light guides, the backlight emitted from each light guide is substantially uniform, which will further simplify the calculation of the compensated display image.

A skilled person in the art will further appreciate that the present invention may be applicable to a scenario in which there exists interference between the light emission from adjacent light guides. Calculation of the compensated display image for each region of the display may be based upon the backlight from limited number of light guides, for example, the corresponding light guide of each region of the display alone or in combination with a pair of adjacent light guides. In this way, the calculation of the compensated display image can still be simplified.

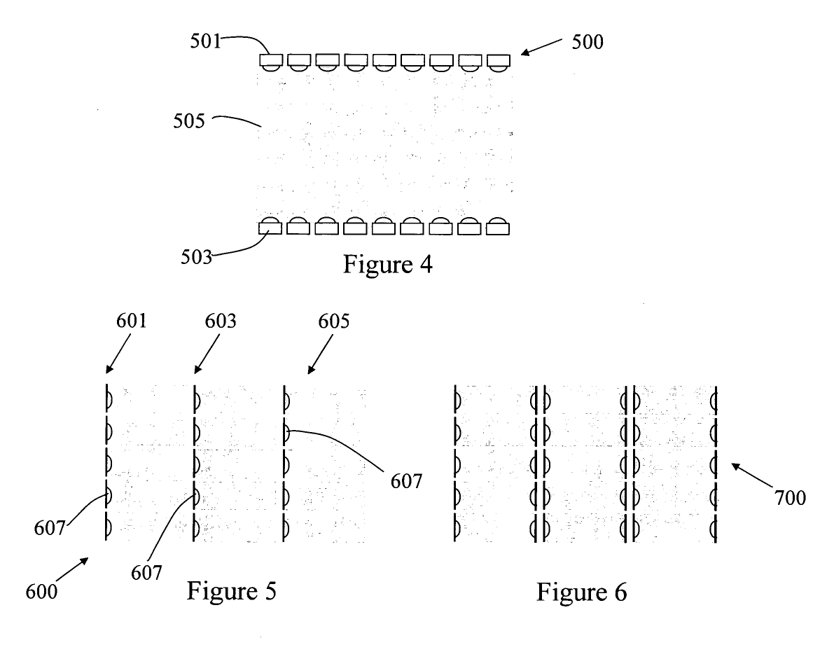

FIG. 4 illustrates a second exemplary embodiment of a side-emitting backlight system 500, similar to the first embodiment, but with two opposed light emitting blocks 501, 503 sharing one light guide 505.

FIG. 5 illustrates a third exemplary embodiment of a side-emitting backlight system 600, functioning similar to the first embodiment, but having a plurality of regions 601, 603, 605 with the light emitting blocks 607 thereon emitting light in the same direction.

FIG. 6 illustrates a fourth exemplary embodiment of a side-emitting backlight system 700 which is substantially a combination of the second and third embodiments.

Alternatives can be made to the exemplary embodiments. For example, cold cathode fluorescent lamps (CCFL) or organic light emitting diode (OLED) films can be used as the light emitting sources, instead of the LEDs.

While the present invention has been explained by reference to the examples or preferred embodiments described above, it will be appreciated that those are examples to assist understanding of the present invention and are not meant to be restrictive. Variations or modifications which are obvious or trivial to persons skilled in the art, as well as improvements made thereon, should be considered as equivalents of this invention.

1. A side-emitting backlight system for an image display panel, the system comprising
a plurality of light emission units, each unit arranged so as to provide side light emission to region of an image display panel and having at least one light emission source; and
a controller for individually controlling each light emission unit to vary at least one light characteristic of light emission from each light emission unit;
wherein the at least one light characteristic is defined by determining at least one predefined parameter of light for each of a plurality of regions of an image to be displayed on the display panel, the region of the image corresponding to an adjacent light emission unit.

2. A system according to claim 1, wherein the controller provides image signal of each said region is provided responsive to the lighting characteristic of a corresponding light emission unit so as to display an image of at least one predetermined visual characteristic.

3. A system according to claim 2, wherein the controller further provides an image to the image display panel.

4. A backlight system according to claim 1, wherein each light emission unit comprises at least one organic light emitting diode (OLED) film.

5. A backlight system according to claim 1, wherein each light emission unit comprises at least one light emitting diode (LED).

6. A backlight system according to claim 1, wherein each light emission unit comprises at least one cold cathode fluorescent lamp (CCFL).

7. A backlight system according to claim 1, wherein each light emission unit includes at least one set of RGB colour-separated LEDs.

8. A backlight system according to claim 1, wherein each light emission includes at least one RGB LED in one package.

9. A backlight system according to claim 1, wherein each light emission unit includes at least one blue or ultraviolet LED coated with phosphor material for downward conversion.

10. A backlight system according to claim 1, further comprising a plurality of light guides for directing light emitted from the light emission units in a direction towards the display panel.

11. A backlight system according to claim 10, wherein each light emission unit has associated therewith one or more light guides.

12. A backlight system according to claim 11, wherein the one or more light guides of each light emission unit direct correspond to the corresponding region of the display panel associated with that light emission source.

13. A backlight system according to claim 10, wherein the light guides are arranged in a manner so as to reduce light interference between adjacent regions of the light emission units.

14. A backlight system according to claim 13, wherein each light guide includes a first side surface adjacent its corresponding group of light emitting sources for incidence of light from the corresponding group of light emitting sources into the light guide, and a second side surface through which light is emitted towards the display panel, and wherein each light guide includes a third side surface which is substantially light-impermeable for minimizing or reducing the interference between the light emission of different light emission units.

15. A backlight system according to claim 13, wherein each light guide includes a first side surface adjacent its corresponding group of light emitting sources for incidence of light from the corresponding group of light emitting sources into the light guide, a second side surface through which light is emitted towards the display panel, and a third side surface which is substantially light-impermeable.

16. A backlight system according to claim 15, wherein the third side surface of each light guide is substantially reflective.

17. A backlight system according to claim 16, wherein the third side surface of each light guide is coated with substantially reflective materials.

18. A backlight system according to claim 14, wherein the second side surface of each light guide is substantially diffusive.

19. The side-emitting backlight system according to claim 1, further comprising a driving unit for receiving a control signal from the controller and for controlling the at least one characteristic of the light emission of each light emission unit.

20. A backlight system according to claim 1, wherein the characteristic of the light emission is the brightness of the light emission of each light emission unit.

21. A backlight system according to claim 1, wherein the characteristic of the light emission is the colour of the light emission of each light emission unit.

22. A backlight system according to claim 1, wherein the characteristic of the light emission is the combination of brightness and colour of the light emission of each light emission unit.

23. A display system comprising,
an image display panel;
a side-emitting backlight system comprising a plurality of light emission units, each unit corresponding to an adjacent region of the image display panel and having at least one light emission source;
a controller for individually controlling each light emission unit to vary at least one light characteristic of light emission from each light emission unit and for providing an image signal to the image display panel,
the region of the image corresponding to an adjacent light emission unit; and
the image signal of each said region is provided responsive to the lighting characteristic of a corresponding light emission unit so as to display an image of at least one predetermined visual characteristic.

24. A display system according to claim 23, wherein the image display panel is a liquid crystal display (LCD).

25. A display system according to claim 23, wherein each light emission unit comprises at least one organic light emitting diode (OLED) film.

26. A display system according to claim 23, wherein each light emission unit comprises at least one light emitting diode (LED).

27. A display system according to claim 23, wherein each light emission unit comprises at least one cold cathode fluorescent lamp (CCFL).

28. A display system according to claim 23, wherein each light emission unit includes at least one set of RGB colour-separated LEDs.

29. A display system according to claim 23, wherein each light emission includes at least one RGB LED in one package.

30. A display system according to claim 23, wherein each light emission unit includes at least one blue or ultraviolet LED coated with phosphor material for downward conversion.

31. A display system according to claim 23, further comprising a plurality of light guides for directing light emitted from the light emission units in a direction towards the display panel.

32. A display system according to claim 31, wherein each light emission unit has associated therewith one or more light guides.

33. A display system according to claim 32, wherein the one or more light guides of each light emission unit direct correspond to the corresponding region of the display panel associated with that light emission source.

34. A display system according to claim 32, wherein the light guides are arranged in a manner so as to reduce light interference between adjacent regions of the light emission units.

35. A display system according to claim 34, wherein each light guide includes a first side surface adjacent its corresponding group of light emitting sources for incidence of light from the corresponding group of light emitting sources into the light guide, and a second side surface through which light is emitted towards the display panel, and wherein each light guide includes a third side surface which is substantially light-impermeable for minimizing or reducing the interference between the light emission of different light emission units.

36. A display system according to claim 34, wherein each light guide includes a first side surface adjacent its corresponding group of light emitting sources for incidence of light from the corresponding group of light emitting sources into the light guide, a second side surface through which light is emitted towards the display panel, and a third side surface which is substantially light-impermeable.

37. A display system according to claim 36, wherein the third side surface of each light guide is substantially reflective.

38. A display system according to claim 37, wherein the third side surface of each light guide is coated with substantially reflective materials.

39. A display system according to claim 35, wherein the second side surface of each light guide is substantially diffusive.

40. The side-emitting backlight system according to claim 23, further comprising a driving unit for receiving a control signal from the controller and for controlling the at least one characteristic of the light emission of each light emission unit.

41. A display system according to claim 23, wherein the characteristic of the light emission is the brightness of the light emission of each light emission unit.

42. A display system according to claim 23, wherein the characteristic of the light emission is the colour of the light emission of each light emission unit.

43. A display system according to claim 21, wherein the controller comprises at least one circuit module.

44. A method of displaying an image on a backlit display, the method comprising the steps of:
determining at least one predefined parameter of light for each of a plurality of regions of an image to be displayed on a backlit display;
providing at least one light characteristic by a plurality of light emission units corresponding to each respective region of said plurality of regions responsive to said predefined parameter; and
providing an image signal to said display, wherein the image signal of each said region of the display is provided responsive to the lighting characteristic of a corresponding light emission unit so as to display an image of at least one predetermined visual characteristic.

45. A method according to claim 44, wherein the light emission units are provided as side-emission light emission units.

46. A method according to claim 45, wherein the predefined parameter is selected from the group including average value, peak value, dimming or intensity value or the like.

47. A method according to claim 44, wherein the light characteristic provided by the light emission units is selected from the group including brightness, colour or combinations thereof.
